(19) United States
(12) Patent Application Publication
(10) Pub. No.: US 2025/0250494 A1
(43) Pub. Date: Aug. 7, 2025

(54) METHOD FOR POLYMERIZING AND UPGRADING BIOMASS PYROLYSIS OIL

(71) Applicant: KOREA INSTITUTE OF SCIENCE AND TECHNOLOGY, Seoul (KR)

(72) Inventors: Jina EUN, Seoul (KR); Jeong-Myeong HA, Seoul (KR); Jae Wook CHOI, Seoul (KR); Young Hyun YOON, Seoul (KR); Dong Jin SUH, Seoul (KR); Chun-Jae YOO, Seoul (KR); Kwang Ho KIM, Seoul (KR); Chang Soo KIM, Seoul (KR); Kyeongsu KIM, Seoul (KR); Hyun Joo LEE, Seoul (KR)

(21) Appl. No.: 18/658,586

(22) Filed: May 8, 2024

(30) Foreign Application Priority Data
Feb. 6, 2024 (KR) 10-2024-0017866

(51) Int. Cl. C10G 69/12

(52) U.S. Cl. CPC C10G 69/126; C10G 2300/1011; C10G 2300/70

(57) ABSTRACT

Disclosed herein is a method of polymerizing and upgrading biomass pyrolysis oil. The method includes the steps of: obtaining a hydrogenation reaction product by adding biomass pyrolysis oil to a first-stage catalyst containing a transition metal supported on carbon; obtaining a first hydrodeoxygenation reaction product by adding the hydrogenation reaction product to a second-stage catalyst containing nickel and iron supported on a metal oxide; obtaining a polymerization reaction product by adding the first hydrodeoxygenation reaction product to a third-stage catalyst containing zeolite; and obtaining a second hydrodeoxygenation reaction product by adding the polymerization reaction product to a fourth-stage catalyst containing a transition metal supported on tungstate zirconia.

### CROSS REFERENCE TO RELATED APPLICATION

The present application claims priority to Korean Patent Application No. 10-2024-0017866 filed on Feb. 6, 2024, the entire contents of which are incorporated herein by reference.

### DESCRIPTION OF GOVERNMENT-SPONSORED RESEARCH

This study was conducted at the Korea Institute of Science and Technology under the management of the Korea Institute of Science and Technology under the Ministry of Science and ICT. The research project name is the Korea Institute of Science and Technology's research operation cost support (main project cost), and the research task name is the Development of Source Technology of Electro Super Cellulose Composite Material (Task Identification Number: 1711196516).

In addition, this study was conducted at the Korea Institute of Science and Technology under the management of the National Research Foundation of Korea under the Ministry of Science and ICT. The research project name is the Development of Climate Change Response Technology, and the research task name is the Development of Deoxygenation Upgrading Catalytic Chemical Process Technology for Producing Bio-jet Fuel from Wood Pyrolysis Oil (Task identification number: 1055001211).

### BACKGROUND OF THE INVENTION

### Field of the Invention

The present disclosure discloses a method of polymerizing and upgrading biomass pyrolysis oil.

### Description of the Related Art

Existing aviation fuel produced from petroleum will be restricted in use from 2026 due to international regulations related to greenhouse gas reduction, and by 2050 in the long term, should be replaced by aviation fuel that contains at least 50% of sustainable aviation fuel (SAF). Among sustainable aviation fuels, hydropreocessed ester and fatty acid (HEFA), which can be produced from animal and vegetable oils, is currently produced and utilized commercially, and ATJ (alcohol-to-jet) derived from bio-alcohol is being confirmed on a pilot or demonstration scale. This sustainable aviation fuel can be used right now because the technical entry barrier is low, but it is difficult to secure raw materials compared to the demand for aviation fuel, so other types of raw materials or new aviation fuel production technology are needed.

When performing a deoxygenation reaction from pyrolysis oil of biomass, long-term operation is difficult due to rapid deactivation, and low-molecular-weight products are mainly obtained through polymerization of high molecular compounds, whereby products mainly in the gasoline range can be obtained, but it is difficult to obtain products that can be used as diesel and aviation oil.

Additionally, biomass pyrolysis oil contains various compounds depending on the type of biomass. Therefore, it is necessary to adjust the fuel chemical properties of the final product through appropriate post-treatment technology to ensure that these compounds have certain properties.

### SUMMARY OF THE INVENTION

In one aspect, the present disclosure aims to provide a method for polymerizing and upgrading biomass pyrolysis oil.

In one aspect, the present disclosure provides a method for polymerizing and upgrading biomass pyrolysis oil, the method including the steps of: obtaining a hydrogenation reaction product by adding biomass pyrolysis oil to a first-stage catalyst containing a transition metal supported on carbon; obtaining a first hydrodeoxygenation reaction product by adding the hydrogenation reaction product to a second-stage catalyst containing nickel and iron supported on a metal oxide; obtaining a polymerization reaction product by adding the first hydrodeoxygenation reaction product to a third-stage catalyst containing zeolite; and obtaining a second hydrodeoxygenation reaction product by adding the polymerization reaction product to a fourth-stage catalyst containing a transition metal supported on tungstate zirconia.

In an exemplary embodiment, the transition metal in the first-stage catalyst may include one or more selected from the group consisting of ruthenium, platinum, palladium, gold, rhodium, iridium, nickel, cobalt, copper, and molybdenum.

In an exemplary embodiment, the hydrogenation reaction may be performed at 150 to 220° C.

In an exemplary embodiment, the metal oxide in the second-stage catalyst may be titania or zirconia.

In an exemplary embodiment, the first hydrodeoxygenation reaction may be performed at 250 to 300° C.

In an exemplary embodiment, the zeolite in the third-stage catalyst may be one or more selected from the group consisting of H-Y, H-ZSM-5, and H-β.

In an exemplary embodiment, the polymerization reaction may be carried out at 160 to 220° C.

In an exemplary embodiment, the transition metal in the fourth-stage catalyst may include one or more selected from the group consisting of ruthenium, platinum, palladium, gold, rhodium, iridium, nickel, cobalt, copper, and molybdenum.

In an exemplary embodiment, the second hydrodeoxygenation reaction may be performed at 200 to 300° C.

In one exemplary embodiment, the method may be performed in a continuous reactor.

In one exemplary embodiment, the method may produce a polymerized, hydrogenated and hydrodeoxygenated hydrocarbon compound.

In one aspect, the technology disclosed in the present disclosure has the effect of providing a method for polymerizing and upgrading biomass pyrolysis oil.

### BRIEF DESCRIPTION OF THE DRAWINGS

FIG. 1 shows the reaction scheme of Example 1-1.

FIG. 2 shows the reaction scheme of Example 1-2.

FIG. 3 shows the reaction scheme of Example 1-3.

FIG. 4 shows the results of analysis of reaction products of Example 1-3.

FIG. 5 shows the results of analysis of reaction products of Example 2-1.

FIG. 6 shows the results of analysis of reaction products of Example 2-3.

FIG. 7 shows the results of analysis of reaction products of Example 2-4.

FIG. 8 shows a flow chart of the reaction of Example 3.

FIG. 9 shows the results of analysis of reaction products of Example 3.

FIG. 10 shows the results of analysis of reaction products of Comparative Example 1.

FIG. 11 shows the results of analysis of reaction products of Comparative Example 2.

FIG. 12 shows the results of analysis of reaction products of Comparative Example 3.

FIG. 13 shows the results of analysis of reaction products of Comparative Example 4.

FIG. 14 shows the results of analysis of reaction products of Comparative Example 5.

FIG. 15 shows the results of analysis of reaction products of Comparative Example 6.

FIG. 16 shows the results of analysis of reaction products of Comparative Example 7.

### DETAILED DESCRIPTION OF THE INVENTION

Hereinafter, the present disclosure will be described in detail.

In one aspect, the present disclosure provides a method for polymerizing and upgrading biomass pyrolysis oil, the method including the steps of: obtaining a hydrogenation reaction product by adding biomass pyrolysis oil to a first-stage catalyst containing a transition metal supported on carbon; obtaining a first hydrodeoxygenation reaction product by adding the hydrogenation reaction product to a second-stage catalyst containing nickel and iron supported on a metal oxide; obtaining a polymerization reaction product by adding the first hydrodeoxygenation reaction product to a third-stage catalyst containing zeolite; and obtaining a second hydrodeoxygenation reaction product by adding the polymerization reaction product to a fourth-stage catalyst containing a transition metal supported on tungstate zirconia.

The method has the effect of producing a high-carbon deoxygenated hydrocarbon compound, such as naphthene, polymerized from biomass pyrolysis oil through a continuous reaction without clogging of a reactor. More specifically, the method has the effect of producing a high-carbon deoxygenated hydrocarbon compound through polymerization of a phenolic compound contained in biomass pyrolysis oil by sequentially performing a hydrogenation reaction using a first-stage catalyst, a selective hydrodeoxygenation reaction using a second-stage catalyst, a polymerization reaction using a third-stage catalyst, and a hydrodeoxygenation reaction using a fourth-stage catalyst.

In an exemplary embodiment, the biomass pyrolysis oil (referred to as biomass thermal decomposition oil) refers to a liquid product obtained by thermal decomposition of biomass, and the pyrolysis oil may be a high viscosity mixture.

In an exemplary embodiment, the biomass pyrolysis oil may be a material obtained by thermally decomposing a biomass raw material using a method such as pyrolysis, hydrothermal liquefaction, and solvothermal liquefaction at a temperature of 300° C. or higher. Through this thermal decomposition, sugars and low-molecular-weight sugar-derived compounds, aromatic compounds, phenol-based compounds, fats and fat-derived compounds, and oligomers or high-molecular compounds polymerized from these low-molecular-weight compounds can be obtained.

In an exemplary embodiment, the biomass may be one or more selected from the group consisting of lignocellulose, cellulose, hemicellulose, lignin, vegetable lipid, macroalgae, microalgae, and carbohydrates.

In an exemplary embodiment, the biomass pyrolysis oil may refer to a decomposition product produced by thermal decomposition of biomass including wood, grass, and algae.

In an exemplary embodiment, the decomposition product may be an oxygen-containing compound containing an unsaturated structure such as aromatic or olefin and/or an oxygen functional group such as aldehyde, carboxylic acid, ketone, alcohol, phenol, ether, or ester.

In an exemplary embodiment, the decomposition product may be an oxygen-containing compound containing a phenol structure.

In an exemplary embodiment, the oxygen-containing compound may be an oxygen-containing hydrocarbon compound.

In an exemplary embodiment, the oxygen-containing compound may be an oxygen-containing aromatic hydrocarbon compound.

In an exemplary embodiment, the oxygen-containing compound may have 5 to 20 carbon atoms, 5 to 15 carbon atoms, or 5 to 10 carbon atoms.

In an exemplary embodiment, the oxygen-containing compound may include one or more selected from the group consisting of syringol, ethyl guaiacol, and propyl phenol.

In an exemplary embodiment, the transition metal in the first-stage catalyst may include one or more selected from the group consisting of ruthenium, platinum, palladium, gold, rhodium, iridium, nickel, cobalt, copper, and molybdenum.

In an exemplary embodiment, the transition metal in the first-stage catalyst may be included in an amount of 1 to 10% by weight based on the total weight of the first-stage catalyst.

In another exemplary embodiment, the transition metal in the first-stage catalyst may be included in an amount of 1% by weight or more, 2% by weight or more, 3% by weight or more, 4% by weight or more, 5% by weight or more, 6% by weight or more, 7% by weight or more, 8% by weight or more, or 9% by weight or more, and 10% by weight or less, 9% by weight or less, 8% by weight or less, 7% by weight or less, 6% by weight or less, 5% by weight or less, 4% by weight or less, 3% by weight or less, or 2% by weight or less, based on the total weight of the first-stage catalyst.

In an exemplary embodiment, the hydrogenation is a reaction that reduces a degree of unsaturation of the oxygen-containing compound and reduces functional groups inducing catalyst deactivation, and may be performed at, for example, 150 to 220° C.

In another exemplary embodiment, the hydrogenation reaction may be performed at a temperature of 150° C. or higher, 160° C. or higher, 170° C. or higher, 180° C. or higher, 190° C. or higher, 200° C. or higher, or 210° C. or higher, and 220° C. or lower, 210° C. or lower, 200° C. or lower, 190° C. or lower, 180° C. or lower, 170° C. or lower or 160° C. or lower.

In an exemplary embodiment, the hydrogenation reaction may be performed for 50 minutes to 150 minutes.

In another exemplary embodiment, the hydrogenation reaction may be performed for 50 minutes or more, 60 minutes or more, 70 minutes or more, 80 minutes or more, 90 minutes or more, 100 minutes or more, 110 minutes or more, 120 minutes or more, 130 minutes or more, or 140 minutes or more, and 150 minutes or less, 140 minutes or less, 130 minutes or less, 120 minutes or less, 110 minutes or less, 100 minutes or less, 90 minutes or less, 80 minutes or less, 70 minutes or less, or 60 minutes or less.

In an exemplary embodiment, the metal oxide in the second-stage catalyst may be titania (titanium dioxide) or zirconia (zirconium oxide). Accordingly, there is an effect of producing a cyclic alcohol compound through a selective deoxygenation reaction and using it to perform a polymerization reaction with a phenol-based compound in a subsequent reaction.

In an exemplary embodiment, the nickel and iron in the second-stage catalyst may be included in an amount of 5 to 50% by weight and 0.5 to 20% by weight, respectively, based on the total weight of the second-stage catalyst.

In another exemplary embodiment, the nickel may be included in an amount of 5% by weight or more, 6% by weight or more, 7% by weight or more, 8% by weight or more, 9% by weight or more, 10% by weight or more, 11% by weight or more, 12% by weight or more, or 13% by weight or more, 14% by weight or more, or 15% by weight or more, and 50% by weight or less, 45% by weight or less, 40% by weight or less, 35% by weight or less, 30% by weight or less, 25% by weight or less, 20% by weight or less, or 15% by weight or less, based on the total weight of the second-stage catalyst. Preferably, the nickel may be included in an amount of 10 to 20% by weight, or 15 to 20% by weight, based on the total weight of the second-stage catalyst.

In another exemplary embodiment, the iron may be included in an amount of 0.5% by weight or more, 1% by weight or more, 1.5% by weight or more, 2% by weight or more, 2.5% by weight or more, or 3% by weight or more, and 20% by weight or less, 19% by weight or less, 18% by weight or less, or 17% by weight or less, 16% by weight or less, or 15% by weight or less, 14% by weight or less, 13% by weight or less, 12% by weight or less, 11% by weight or less, 10% by weight or less, 9% by weight or less, 8% by weight or less, 7% by weight or less, 6% by weight or less, 5% by weight or less, 4% by weight or less, or 3% by weight or less, based on the total weight of the second-stage catalyst. Preferably, the iron may be included in an amount of 1 to 5% by weight, or 3 to 5% by weight, based on the total weight of the second-stage catalyst.

In an exemplary embodiment, the nickel and iron in the second-stage catalyst may be included in a weight ratio of 3 to 20:1, preferably 3 to 15:1, 3 to 10:1, 4 to 8:1, 4 to 6:1, 4 to 5:1, 5 to 6:1, or 5:1.

In an exemplary embodiment, the second-stage catalyst may be obtained by hydrothermal synthesis.

In an exemplary embodiment, the second-stage catalyst may be obtained by mixing a basic material with an aqueous solution containing a metal oxide carrier and precursors of nickel and iron.

In an exemplary embodiment, the first hydrodeoxygenation is a reaction of removing oxygen atoms in the molecule of the oxygen-containing compound by adding hydrogen, and may be performed at, for example, 250 to 300° C.

In another exemplary embodiment, the first hydrodeoxygenation reaction may be performed at a temperature of 250° C. or higher, 260° C. or higher, 270° C. or higher, 280° C. or higher, or 290° C. or higher, and 300° C. or lower, 290° C. or lower, 280° C. or lower, 270° C. or lower, 260° C. or lower.

In an exemplary embodiment, the first hydrodeoxygenation reaction may be performed for 50 minutes to 150 minutes.

In another exemplary embodiment, the first hydrodeoxygenation reaction may be performed for 50 minutes or more, 60 minutes or more, 70 minutes or more, 80 minutes or more, 90 minutes or more, 100 minutes or more, 110 minutes or more, 120 minutes or more, 130 minutes or more, or 140 minutes or more, and 150 minutes or less, 140 minutes or less, 130 minutes or less, 120 minutes or less, 110 minutes or less, 100 minutes or less, 90 minutes or less, 80 minutes or less, 70 minutes or less, or 60 minutes or less.

In an exemplary embodiment, the zeolite in the third-stage catalyst is a zeolite ion-exchanged with hydrogen, and may be one or more selected from the group consisting of H-Y, H-ZSM-5, and H-β. Accordingly, high-carbon hydrocarbon compounds can be produced through the polymerization reaction of phenol-based compounds.

In an exemplary embodiment, the polymerization reaction may be carried out at 160 to 220° C.

In another exemplary embodiment, the polymerization reaction may be performed at a temperature of 160° C. or higher, 170° C. or higher, 180° C. or higher, 190° C. or higher, 200° C. or higher, or 210° C. or higher, and 220° C. or lower, 210° C. or lower, 200° C. or lower, 190° C. or lower, 180° C. or lower, or 170° C. or lower.

In an exemplary embodiment, the polymerization reaction may be carried out for 2 to 4 hours.

In another exemplary embodiment, the polymerization reaction may be performed for 2 hours or more, or 3 hours or less, and 4 hours or less, or 3 hours or less.

In an exemplary embodiment, it may be desirable that the transition metal in the fourth-stage catalyst includes one or more selected from the group consisting of ruthenium, platinum, palladium, gold, rhodium, iridium, nickel, cobalt, copper, and molybdenum in order to improve hydrodeoxygenation reaction efficiency.

In an exemplary embodiment, the transition metal in the fourth-stage catalyst may be included in an amount of 1 to 10% by weight based on the total weight of the fourth-stage catalyst.

In another exemplary embodiment, the transition metal in the fourth-stage catalyst may be included in an amount of 1% by weight or more, 2% by weight or more, 3% by weight or more, 4% by weight or more, 5% by weight or more, 6% by weight or more, 7% by weight or more, 8% by weight or more, or 9% by weight or more, and 10% by weight or less, 9% by weight or less, 8% by weight or less, 7% by weight or less, 6% by weight or less, 5% by weight or less, 4% by weight or less, 3% by weight or less, or 2% by weight or less, based on the total weight of the fourth-stage catalyst.

In an exemplary embodiment, the second hydrodeoxygenation is a reaction of removing oxygen atoms in the molecule of the oxygen-containing compound by adding hydrogen, and may be performed at 200 to 300° C.

In an exemplary embodiment, the second hydrodeoxygenation reaction may be performed at a temperature of 200° C. or higher, 210° C. or higher, 220° C. or higher, 230° C. or higher, 240° C. or higher, 250° C. or higher, 260° C. or higher, 270° C. or higher, 280° C. or higher, or 290° C. or higher, and 300° C. or lower, 290° C. or lower, 280° C. or lower, 270° C. or lower, 260° C. or lower, 250° C. or lower, 240° C. or lower, 230° C. or lower, 220° C. or lower, or 210° C. or lower.

In an exemplary embodiment, the second hydrodeoxygenation reaction may be performed for 50 minutes to 150 minutes.

In another exemplary embodiment, the second hydrodeoxygenation reaction may be performed for 50 minutes or more, 60 minutes or more, 70 minutes or more, 80 minutes or more, 90 minutes or more, 100 minutes or more, 110 minutes or more, 120 minutes or more, 130 minutes or more, or 140 minutes or more, and 150 minutes or less, 140 minutes or less, 130 minutes or less, 120 minutes or less, 110 minutes or less, 100 minutes or less, 90 minutes or less, 80 minutes or less, 70 minutes or less, or 60 minutes or less.

In one exemplary embodiment, the method may be performed in a continuous reactor.

In an exemplary embodiment, the method may use biomass pyrolysis oil as a reactant to produce a polymerized, hydrogenated and hydrodeoxygenated hydrocarbon compound.

Hereinafter, the present disclosure will be described in more detail by way of examples. These examples are only for illustrating the present disclosure, and it will be obvious to those skilled in the art that the scope of the present disclosure is not interpreted as limited by these examples.

### PREPARATION EXAMPLE

Catalysts were prepared and used in the following examples and comparative examples as follows.

### (1) Pd/C

A Pd/C catalyst including palladium (Pd) supported in an amount of 5% by weight based on the total weight of the catalyst was purchased from Sigma-Aldrich and used.

### (2) NiFe/TiO₂

1.49 g of a nickel nitrate hexahydrate (Ni(NO₃)₂·6H₂O) and 0.43 g of an iron nitrate nonahydrate (Fe(NO₃)₃·9H₂O) were dissolved in 20 mL of ion-exchanged water, 1.64 g of a titania (TiO₂, P25) metal oxide support was added thereto, and then mixed by ultrasonic treatment for 30 minutes. While stirring at room temperature, 30 mL of an aqueous ammonium carbonate solution (NH₄HCO₃, 1 M) was added dropwise. After heating at 150° C. for 15 hours, it was slowly cooled to room temperature, and the prepared solid was filtered under vacuum. The prepared solid powder was washed with ion-exchanged water and continued to be washed until the washing solution reached pH 7, and then washed three times with 50 mL of ethanol. The solid powder was dried at 105° C. for 16 hours and calcined at 300° C. for 2 hours under a nitrogen atmosphere. After calcination, it was reduced with 5% by volume hydrogen gas diluted with argon (H₂/Ar) for 4 hours at 450° C. A NiFe/TiO₂ catalyst containing 15 wt % of Ni and 3 wt % of Fe based on the total weight of the catalyst was obtained.

### (3) HY

HY catalyst (Si/Al₂=30 mol/mol) was purchased from Alfa Aesar and used.

### (4) Ru/WZr

Tungstate-zirconia (WZr) was purchased from MEL Chemicals and used. The tungstate-zirconia (WZr) was calcined at 800° C. under an air atmosphere for 8 hours to prepare a calcined tungstate-zirconia (WZr(C) carrier. 1.269 g of ruthenium chloride hydrate (RuCl₃·xH₂O), a ruthenium precursor, and 20 g of WZr(C) were mixed in 200 mL of ion-exchanged water and stirred at room temperature for 30 minutes. The mixture was dried under vacuum at 50° C. and dried under air at 105° C. for 12 hours. The obtained solid was pulverized into powder and then reduced at 350° C. for 4 hours in a flow of 5% by volume hydrogen gas diluted with argon (H₂/Ar). The reduced catalyst was surface treated with oxygen by flowing 1% by volume oxygen gas diluted with nitrogen gas (O₂/N₂) at room temperature for 30 minutes to obtain a Ru/WZr catalyst containing 3% by weight of Ru based on the total weight of the catalyst.

### Example 1-1

At room temperature and atmospheric pressure, 0.3 g of syringol, 0.3 g of ethyl guaiacol, 0.3 g of propyl phenol, and 0.2 g of NiFe/TiO₂ were mixed with 30 mL of n-decane, and put into a batch reactor. After the reactor was sealed, 5 MPa of H₂ was injected at room temperature while stirring the mixture, and the reactor was heated to raise the temperature of the mixture from room temperature to 270° C. After the reaction was carried out at this temperature for 1 hour, the temperature was cooled to room temperature, the pressure was lowered to atmospheric pressure by discharging the high-pressure gas, and then the products in the reactor were analyzed (initial reaction pressure of 5 MPa H₂ at room temperature; reaction temperature of 270° C.; reaction time of 1 hour).

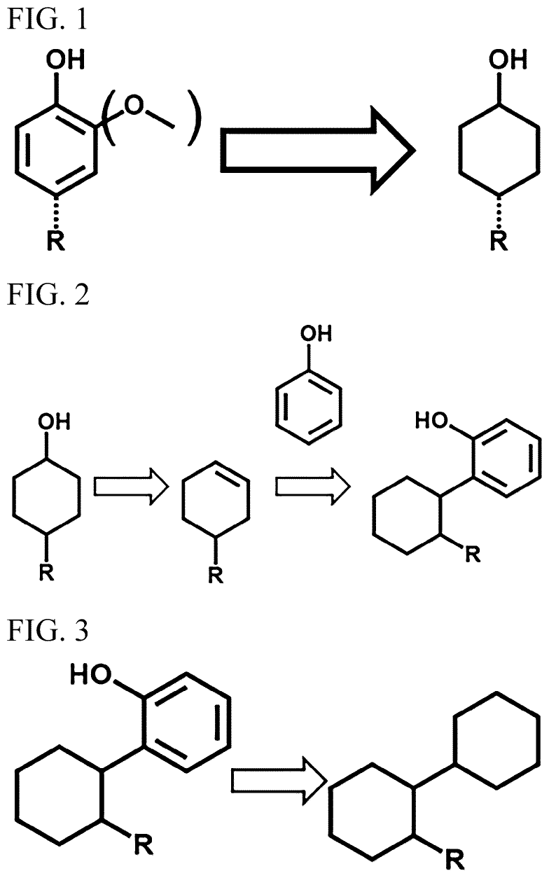

After the reaction, 12% of cycloalkane, 79% of cyclic alcohol (4-propyl cyclohexanol, 4-ethyl cyclohexanol, cyclohexanol, etc.), and 8% of ether compound were obtained (see FIG. 1). Accordingly, it could be seen that most of the reactants were converted to alcohol.

### Example 1-2

To the batch reactor, 10 g of the reaction product of Example 1-1 was added, 20 mL of n-decane was additionally added, and 0.1 g of a commercial catalyst in Table 1 below and 0.2 g of phenol were added. 4 MPa of H₂ was injected at room temperature while stirring the mixture, and the reactor was heated to raise the temperature of the mixture to 160° C. After the reaction was carried out at this temperature for 3 hour, the temperature was cooled to room temperature, and the reaction products were analyzed (initial reaction pressure of 4 MPa H₂ at room temperature; reaction temperature of 160° C.; reaction time of 3 hour). The distribution of the reaction products is shown in Table 1 below.

TABLE 1

| | | Cyclic | | | | |
|---|---|---|---|---|---|---|
| | Phenol | alcohols | Monomer | Dimer | Trimer | Coke |
| Catalyst | (%) | (%) | (%) | (%) | (%) | (%) |
| HY | 31 | 0 | 40 | 28 | 0.5 | 11 |
| (Si/Al₂ = 60 | | | | | | |
| mol/mol, Alfa | | | | | | |
| Aesar ™) | | | | | | |
| Hβ | 33 | 0 | 40 | 26 | 0.9 | 10 |
| (Si/Al₂ = 38 | | | | | | |
| mol/mol, Alfa | | | | | | |
| Aesar ™) | | | | | | |
| Tungstate zirconia | 39 | 0 | 43 | 17 | 1.3 | 1 |
| (MEL | | | | | | |
| Chemicals ™) | | | | | | |
| Sulfated zirconia | 40 | 0 | 60 | 1 | 0 | 0.9 |
| (Alfa Aesar ™) | | | | | | |
| γ-alumina | 28 | 30 | 42 | 0 | 0 | 0.04 |
| (Alfa Aesar ™) | | | | | | |
| Silica-alumina | 43 | 0 | 60 | 0 | 0 | 2.3 |
| (Sigma-Aldrich ®) | | | | | | |

From the experimental results, it was confirmed that when HY, Hβ, and tungstate zirconia were used, dimers and trimers were generated, and thus, these catalysts could be used in polymerization reactions (see FIG. 2).

### Example 1-3

To the batch reactor, 10 g of the reaction product of Example 1-2 was added, 20 mL of n-decane was additionally added, and 0.15 g of Ru/WZr catalyst was added. 5 MPa of H₂ was injected at room temperature while stirring the mixture, and the reactor was heated to raise the temperature of the mixture to 200° C. After the reaction was carried out at this temperature for 1 hour, the temperature was cooled to room temperature, and the reaction products were analyzed (initial reaction pressure of 5 MPa H₂ at room temperature; reaction temperature of 200° C.; reaction time of 1 hour).

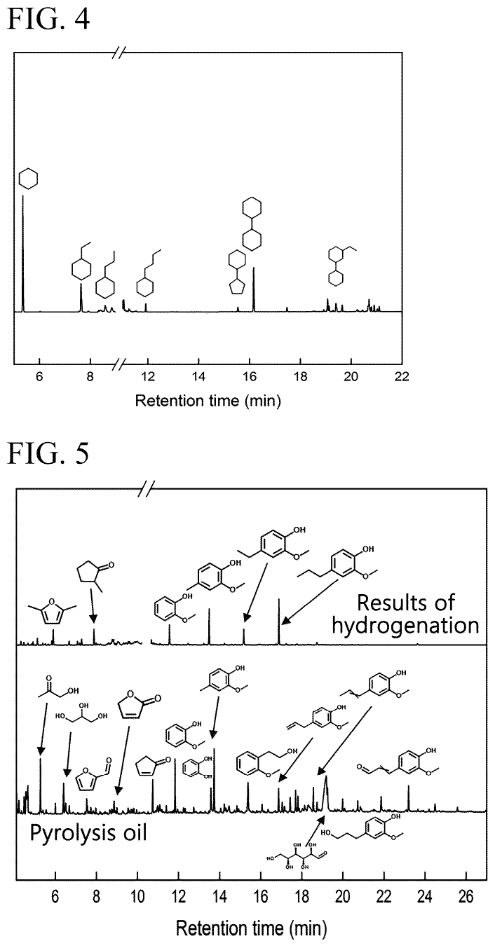

As a result of analyzing the reaction products by GC, it was confirmed that deoxygenated compounds were produced as shown in FIGS. 3 and 4. It was confirmed that dimers of hydrodeoxygenated compounds were produced through the reactions of Examples 1-1 to 1-3.

### Example 2-1

To the batch reactor, 6 g of biomass pyrolysis oil purchased from Biomass Technology Group (BTG) was added, 50 mL of n-decane was additionally added, and 0.5 g of Pd/C catalyst was added. 5 MPa of H₂ was injected at room temperature while stirring the mixture, and the reactor was heated to raise the temperature of the mixture to 200° C. After the reaction was carried out at this temperature for 1 hour, the temperature was cooled to room temperature, and the reaction products were analyzed (initial reaction pressure of 5 MPa H₂ at room temperature; reaction temperature of 200° C.; reaction time of 1 hour).

As a result of the hydrogenation reaction using a Pd/C catalyst, it was confirmed that the raw material of biomass pyrolysis oil was partially hydrogenated and stabilized (see FIG. 5).

### Example 2-2

To the batch reactor, 30 g of the reaction product of Example 2-1 was added, and 0.25 g of NiFe/TiO₂ catalyst was added. 5 MPa of H₂ was injected at room temperature while stirring the mixture, and the reactor was heated to raise the temperature of the mixture to 270° C. After the reaction was carried out at this temperature for 1 hour, the temperature was cooled to room temperature, and the reaction products were analyzed (initial reaction pressure of 5 MPa H₂ at room temperature; reaction temperature of 270° C.; reaction time of 1 hour).

As a result of the hydrodeoxygenation reaction using the NiFe/TiO₂ catalyst, it was confirmed that 72% of cyclic alcohol and 20% of alkyl alcohol were produced.

### Example 2-3

To the batch reactor, 25 g of the reaction product of Example 2-2 and 0.5 g of phenol were added, and 0.15 g of the HY, Hβ or tungstate zirconia catalyst used in Example 1-2 was added. 4 MPa of H₂ was added at room temperature while stirring the mixture, and the reactor was heated to raise the temperature of the mixture to 160° C. After the reaction was carried out at this temperature for 3 hour, the temperature was cooled to room temperature, and the reaction products were analyzed (initial reaction pressure of 4 MPa H₂ at room temperature; reaction temperature of 160° C.; reaction time of 3 hour).

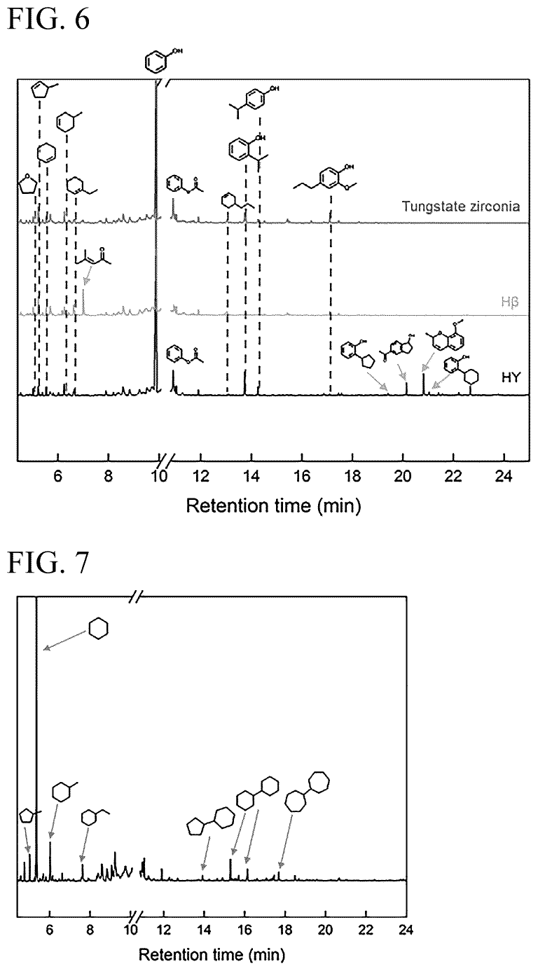

As a result of the polymerization reaction using the HY, Hβ, or tungstate zirconia catalyst, it was confirmed that in the case of using the HY catalyst, polymers were produced when performing the continuous reaction using the biomass pyrolysis oil as a reactant (see FIG. 6).

### Example 2-4

To the batch reactor, 30 g of the reaction product of Example 2-3 using the HY catalyst was added, and 0.25 g of Ru/WZr catalyst was added. 5 MPa of H₂ was injected at room temperature while stirring the mixture, and the reactor was heated to raise the temperature of the mixture to 200° C. After the reaction was carried out at this temperature for 1 hour, the temperature was cooled to room temperature, and the reaction products were analyzed (initial reaction pressure of 5 MPa H₂ at room temperature; reaction temperature of 200° C.; reaction time of 1 hour).

As a result of the hydrodeoxygenation reaction using the Ru/WZr catalyst, it was confirmed that a monomers or dimer of cycloalkane was produced (see FIG. 7).

### Example 3

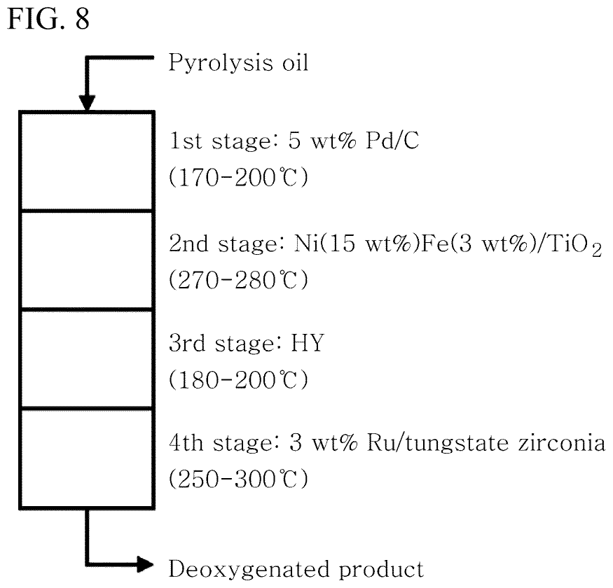

Pd/C (2.5 g), NiFe/TiO₂ (5 g), HY (5 g), and Ru/WZr (2.5 g) catalysts were placed in a continuous reactor from the upper stage, and the temperatures of the stages were set to 170-200° C., 270-280° C., 180-200° C., and 250-300° C. in order from the upper stage, respectively (see FIG. 8). Biomass pyrolysis oil purchased from Biomass Technology Group (BTG) was added as a reactant, and a deoxygenated compound was obtained from the lower stage (reaction pressure: 10 MPa of hydrogen).

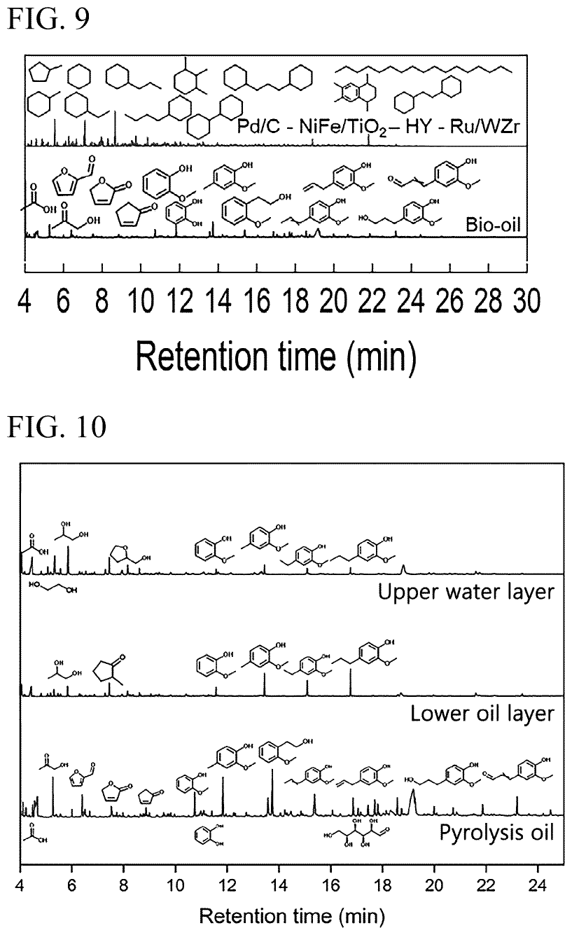

As shown in FIG. 9, it was confirmed that various deoxygenated saturated hydrocarbons and cycloalkane compounds were produced from biomass pyrolysis oil as a result of the four-stage continuous reaction (propylcyclohexane (9.1%), methylcyclohexane (7.2%), ethylcyclohexane (5.7%), 1,3-dimethylcyclohexane (3.1%), heptadecane (3.0%), 1-ethyl-3-methylcyclohexane (2.6%), 1,2,4-trimethylbenzene (2.6%), cyclohexane (2.5%), 1,2,3-trimethylcyclohexane (2.4%), buthylcyclohexane (2.2%)). In addition, it was confirmed that stable operation was conducted for 20 hours or more without clogging of the reactor during continuous operation.

### Comparative Example 1

Pd/C (5 g) catalyst was placed in a continuous reactor from the upper stage, and the temperature of the catalyst layer was set to 160° C. (reaction performed in one step). Biomass pyrolysis oil purchased from Biomass Technology Group (BTG) was added as a reactant, and a product was obtained from the lower stage after the reaction (reaction pressure: 10 MPa of hydrogen).

As a result of the reaction, a product composed of an upper water layer and a lower oil layer was obtained, and a phenol-based compound and a low-molecular-weight oxygen-containing compound were confirmed in each layer (see FIG. 10).

### Comparative Example 2

Pd/C (2.5 g) and NiFe/TiO₂ (5 g) catalysts were placed in a continuous reactor from the upper stage, and the temperatures of the catalyst layers were set to 160° C. and 290° C., respectively (reaction performed in two steps). Biomass pyrolysis oil purchased from Biomass Technology Group (BTG) was added as a reactant, and a product was obtained from the lower stage after the reaction (reaction pressure: 10 MPa of hydrogen).

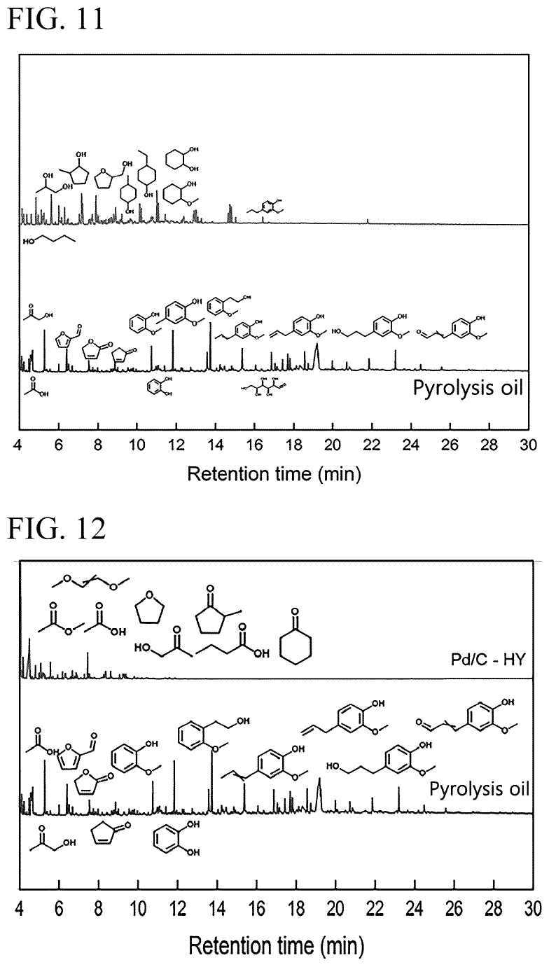

As a result of the reaction, it was confirmed that hydrogenated compounds in the form of cyclic alcohols were mainly produced (see FIG. 11).

### Comparative Example 3

Pd/C (2.5 g) and HY (5 g) catalysts were placed in a continuous reactor from the upper stage, and the temperatures of the catalyst layers were set to 160° C. and 190° C., respectively (reaction performed in two steps). Biomass pyrolysis oil purchased from Biomass Technology Group (BTG) was added as a reactant, and a product was obtained from the lower stage after the reaction (reaction pressure: 10 MPa of hydrogen).

As a result of the reaction, a compound including a ring that had undergone some degree of hydrogenation, and an ester, ketone, alcohol, etc. including a carbonyl group were identified (see FIG. 12).

### Comparative Example 4

Pd/C (2.5 g), HY (5 g), and Ru/WZr (10 g) catalysts were placed in a continuous reactor from the upper stage, and the temperatures of the catalyst layers were set to 160° C., 250° C. and 300° C., respectively (reaction performed in three steps). Biomass pyrolysis oil purchased from Biomass Technology Group (BTG) was added as a reactant, and a product was obtained from the lower stage after the reaction (reaction pressure: 10 MPa of hydrogen).

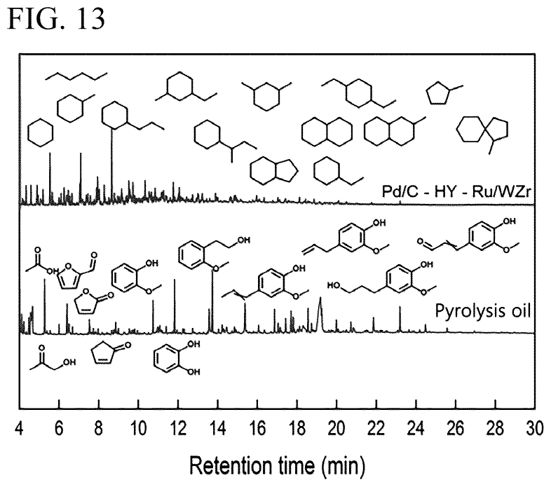

As a result of the reaction, it was confirmed that various hydrogenated and hydrodeoxygenated saturated hydrocarbons and cycloalkane compounds were produced (see FIG. 13). However, unlike Example 3 in which the reaction was carried out in four steps using NiFe/TiO₂ as a second-stage catalyst, it was found that alcohol production did not proceed, and thus, the polymerization did not occur in the subsequent post-stage reaction. In addition, during the continuous operation, reactor clogging occurred after 10 hours, making continuous operation for a long time impossible.

### Comparative Example 5

Pd/C (2.5 g), NiFe/TiO₂ (5 g), and Ru/WZr (7.5 g) catalysts were placed in a continuous reactor from the upper stage, and the temperatures of the catalyst layers were set to 160° C., 290° C. and 200° C., respectively (reaction performed in three steps). Biomass pyrolysis oil purchased from Biomass Technology Group (BTG) was added as a reactant, and a product was obtained from the lower stage after the reaction (reaction pressure: 10 MPa of hydrogen).

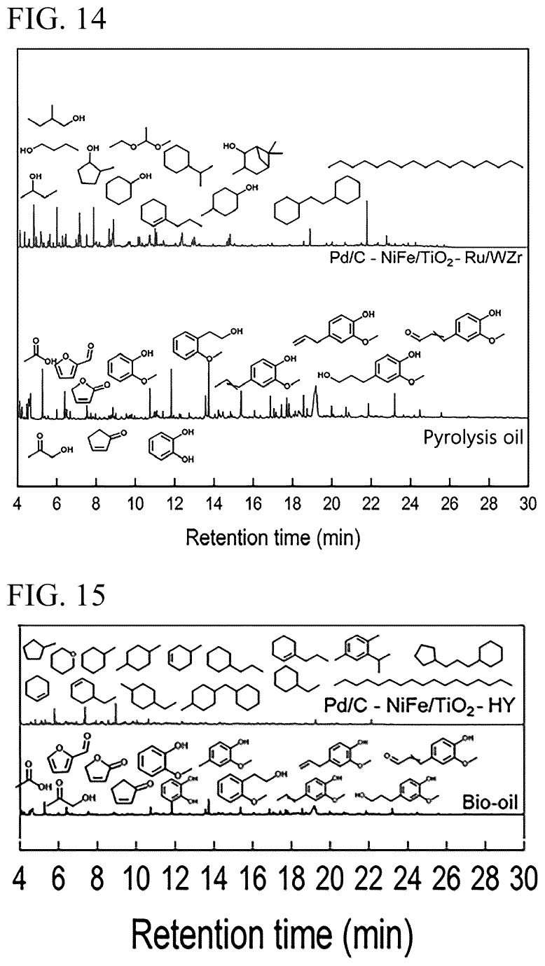

As a result of the reaction, products containing cyclic alcohols and various saturated cyclic compounds were identified (see FIG. 14).

### Comparative Example 6

Pd/C (2.5 g), NiFe/TiO₂ (5 g), and HY (5 g) catalysts were placed in a continuous reactor from the upper stage, and the temperatures of the catalyst layers were set to 160° C., 270° C. and 180° C., respectively (reaction performed in three steps). Biomass pyrolysis oil purchased from Biomass Technology Group (BTG) was added as a reactant, and a product was obtained from the lower stage after the reaction (reaction pressure: 10 MPa of hydrogen).

As a result of the reaction, products containing various saturated or unsaturated cyclic compounds were identified (see FIG. 15). In particular, it was confirmed that the hydrogenation reaction was incomplete and thus, a large amount of cycloalkene, an unsaturated cyclic compound, was produced.

### Comparative Example 7

NiFe/TiO₂ (5 g), HY (2.5 g), and Ru/WZr (7.5 g) catalysts were placed in a continuous reactor from the upper stage, and the temperatures of the catalyst layers were set to 270° C., 190° C. and 300° C., respectively (reaction performed in three steps). Biomass pyrolysis oil purchased from Biomass Technology Group (BTG) was added as a reactant, and a product was obtained from the lower stage after the reaction (reaction pressure: 10 MPa of hydrogen).

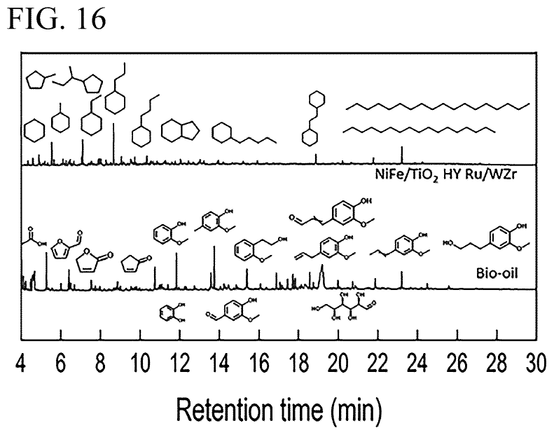

As a result of the reaction, deoxygenated products mainly containing cyclic saturated hydrocarbons were obtained, but the reaction could not be performed due to reactor clogging after 14 hours during the continuous operation, making continuous operation for a long time impossible (see FIG. 16).

As confirmed in Comparative Examples 1 to 7, it was found that even when the same hydrogenation or hydrodeoxygenation catalyst was used, different results were obtained depending on the order of catalyst use.

The specific contents of the present disclosure have been described in detail above, and for those skilled in the art, these specific descriptions are merely preferred embodiments, and the scope of the present disclosure is not limited thereto. Accordingly, it can be said that the substantial scope of the present disclosure is defined by the appended claims and their equivalents.

What is claimed is:

1. A method for polymerizing and upgrading biomass pyrolysis oil, the method comprising the steps of:
obtaining a hydrogenation reaction product by adding biomass pyrolysis oil to a first-stage catalyst comprising a transition metal supported on carbon;
obtaining a first hydrodeoxygenation reaction product by adding the hydrogenation reaction product to a second-stage catalyst comprising nickel and iron supported on a metal oxide;
obtaining a polymerization reaction product by adding the first hydrodeoxygenation reaction product to a third-stage catalyst comprising zeolite; and
obtaining a second hydrodeoxygenation reaction product by adding the polymerization reaction product to a fourth-stage catalyst comprising a transition metal supported on tungstate zirconia.

2. The method for polymerizing and upgrading biomass pyrolysis oil according to claim 1, wherein the transition metal in the first-stage catalyst comprises one or more selected from the group consisting of ruthenium, platinum, palladium, gold, rhodium, iridium, nickel, cobalt, copper, and molybdenum.

3. The method for polymerizing and upgrading biomass pyrolysis oil according to claim 1, wherein the hydrogenation reaction is performed at 150 to 220° C.

4. The method for polymerizing and upgrading biomass pyrolysis oil according to claim 1, wherein the metal oxide in the second-stage catalyst is titania or zirconia.

5. The method for polymerizing and upgrading biomass pyrolysis oil according to claim 1, wherein the first hydrodeoxygenation reaction is performed at 250 to 300° C.

6. The method for polymerizing and upgrading biomass pyrolysis oil according to claim 1, wherein the zeolite in the third-stage catalyst is one or more selected from the group consisting of H-Y, H-ZSM-5, and H-β.

7. The method for polymerizing and upgrading biomass pyrolysis oil according to claim 1, wherein the polymerization reaction is performed at 160 to 220° C.

8. The method for polymerizing and upgrading biomass pyrolysis oil according to claim 1, wherein the transition metal in the fourth-stage catalyst comprises one or more selected from the group consisting of ruthenium, platinum, palladium, gold, rhodium, iridium, nickel, cobalt, copper, and molybdenum.

9. The method for polymerizing and upgrading biomass pyrolysis oil according to claim 1, wherein the second hydrodeoxygenation reaction is performed at 200 to 300° C.

10. The method for polymerizing and upgrading biomass pyrolysis oil according to claim 1, wherein the method is performed in a continuous reactor.

11. The method for polymerizing and upgrading biomass pyrolysis oil according to claim 1, wherein the method produces a polymerized, hydrogenated and hydrodeoxygenated hydrocarbon compound.
